(19) United States
(12) Patent Application Publication
(10) Pub. No.: US 2006/0109674 A1
(43) Pub. Date: May 25, 2006

(54) Blacklight module

(75) Inventors: Der-Woei Hsaio, Chu-Nan (TW); Bor-Jyh Pan, Chu-Nan (TW); Ching-Chung Lin, Chu-Nan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/138,453

(22) Filed: May 27, 2005

(30) Foreign Application Priority Data
Nov. 24, 2004 (TW) 093136075

(51) Int. Cl. F21V 15/04

(52) U.S. Cl. 362/551; 362/390

(57) ABSTRACT

The present invention relates to a backlight module, wherein by disposing buffer elements in the edges and/or below the plate lamp, the plate lamp of the backlight module can avoid the damage resulting from an external force. In addition to a vibration-resistant effect, the buffer elements disposed below the bottom of the plate lamp can further maintain a uniform spacing between the plate lamp and the rear frame so that the light-emitting efficiency, brightness uniformity, and operation can be maintained.

### FIELD OF THE INVENTION

The present invention relates to a backlight module, particularly to a backlight module, wherein the external force acting on the plate lamp inside is buffered, and appropriate protection for the plate lamp is provided, and the light-emitting efficiency and brightness uniformity can be maintained.

### BACKGROUND OF THE INVENTION

Among the light sources of the current backlight module, a plate lamp is gradually adopted owing to its well light-emitting efficiency, brightness uniformity and capability to provide a planar light source of large area. The plasma light-emitting element is one type of the plate lamp, wherein a high potential difference between the cathode and the anode of the gas-discharging cavity is applied to excite the inert gas thereof into high energy gaseous excited-state molecules, ions and electrons i.e. the so-called plasma. Thereafter, the excited-state atoms in the plasma emit the ultra-violet ray to release the energy, and then the ultra-violet ray further excites the fluorescent material of the plate lamp to emit a visible light.

A conventional backlight module 10, as shown in FIG. 1, includes a plate lamp 11, a rear frame 12, a diffuser plate 16, an optical film layer 18, a front frame 13, a plurality of plate lamp supporting elements 14 and a plurality of diffuser plate supporting elements 15. The plate lamp supporting elements 14 are disposed on the rear frame 12, and the diffuser plate supporting elements 15 are disposed on the plate lamp supporting elements 14, and the plate lamp supporting elements 14 and the diffuser plate supporting elements 15 clamp the edges of the plate lamp 111 to enable the plate lamp 11 to be accommodated inside the rear frame 12. The front frame 13 is disposed over the rear frame 12 for supporting a liquid crystal panel 20, and fixing the optical film layer 18, the diffuser plate 16 and the plate lamp 11 between the front frame 13 and the rear frame 12. The diffuser plate supporting elements 15 support the diffuser plate 16 and the optical film layer 18 in order to improve the brightness and light uniformity. Additionally, the liquid crystal panel 20 utilizing the planar light source provided by the plate lamp 11 of the backlight module 10 is disposed over the front frame 13 to enable the displaying function.

Although the plate lamp supporting elements 14 and the diffuser plate supporting elements 15 of the conventional backlight module 10 can limit the displacement of the plate lamp 11, when an external force impacts the backlight module 10, the external force is transmitted to the plate lamp 11 through the plate lamp supporting elements 14 and the diffuser plate supporting elements 15, inducing the breakage of the edge of the plate lamp 11 and then the leakage of the gas existing inside the plate lamp 11. Therefore, the function of the plate lamp 11 is affected.

Further, as the size of the backlight module grows larger and larger with the current trend, the flatness of the rear frame 12 is harder to maintain, resulting the inability to maintain the uniform spacing between the plate lamp 11 and the rear frame 12, e.g. d2<d1, as shown in the figure, and thus the operation of the backlight module 10 is affected. For an external-electrode type plate lamp 11, as the electrodes 17 are disposed on the external surface of the plate lamp 11, the current leakage probably occurs owing to that the rear frame 12 is too close to or contacts the electrodes of the plate lamp 11 when the uniform spacing between the plate 11 and the rear frame 12 can no longer be maintained; thus, the light-emitting efficiency and the brightness uniformity of the backlight module 10 are affected.

### SUMMARY OF THE INVENTION

The objective of the present invention is to provide a backlight module, wherein the external force acting on the plate lamp inside is buffered, and the light-emitting efficiency, brightness uniformity and the operation of the backlight module can be maintained.

According to the above-mentioned objective, the present invention provides a backlight module including a plate lamp, a rear frame, a diffuser plate, an optical film layer, a front frame and a plurality of buffer elements, wherein the front frame is disposed over the rear frame for supporting a liquid crystal panel and fixing the optical film layer, the diffuser plate and the plate lamp between the front frame and the rear frame. The buffer elements are disposed on the rear frame and wrap the edges of the plate lamp in order to protect the plate lamp of the backlight module from the damage resulting from an external force.

According to the above-mentioned objective, the present invention further provides a backlight module including a plate lamp, a rear frame, a diffuser plate, an optical film layer, a front frame and a plurality of buffer elements, wherein the front frame is disposed over the rear frame for supporting a liquid crystal panel and fixing the optical film layer, the diffuser plate and the plate lamp between the front frame and the rear frame. The buffer elements are disposed between the rear frame and the plate lamp in order to maintain a predetermined spacing between the plate lamp and the rear frame and protect the plate lamp of the backlight module from the damage resulting from an external force, for maintaining the light-emitting efficiency, the brightness uniformity and the operation thereof.

By disposing the buffer elements in the edges and/or below the bottom of the plate lamp, the plate lamp of the backlight module in the present invention is protected from the damage resulting from an external force, wherein the buffer elements disposed below the plate lamp not only have the vibration-resistant effect, but also maintain a predetermined spacing between the plate lamp and the rear frame, so that the light-emitting efficiency, brightness uniformity and electric operation can be maintained.

From the preferred embodiments described below in conjunction with the accompanying drawings, the above-mentioned and other objectives, characteristics, and advantages of the present invention are to be better understood.

### BRIEF DESCRIPTION OF THE DRAWINGS

FIG. 1 is a schematic sectional diagram of the structure in a conventional backlight module.

FIG. 2 is a sectional diagram of the structure of the backlight module according to one aspect of the present invention.

FIG. 3 is a diagram of the buffer element disposed in the edge of the plate lamp according to one preferred embodiment of the present invention.

FIG. 4 is a diagram of the buffer element disposed in the edge of the plate lamp according to another preferred embodiment of the present invention.

FIG. 5 is a diagram of the buffer element disposed below the bottom of the plate lamp according to one preferred embodiment of the present invention.

FIG. 6A and FIG. 6B are diagrams of the buffer element disposed on the rear frame according to one preferred embodiment of the present invention.

FIG. 7 is a perspective diagram of the buffer element disposed below the bottom of the plate lamp according to another preferred embodiment of the present invention.

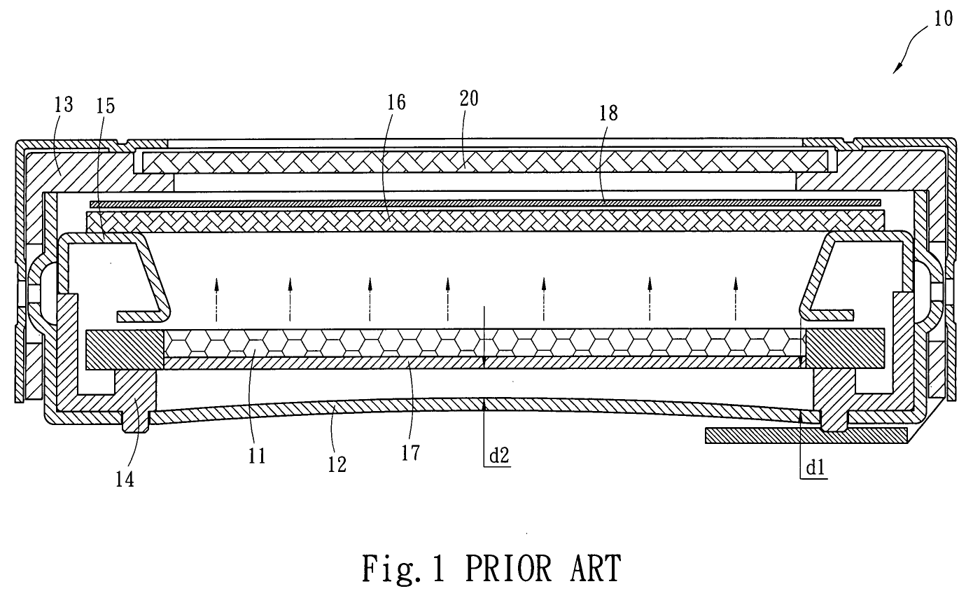

### DETAILED DESCRIPTION OF THE PREFERRED EMBODIMENTS

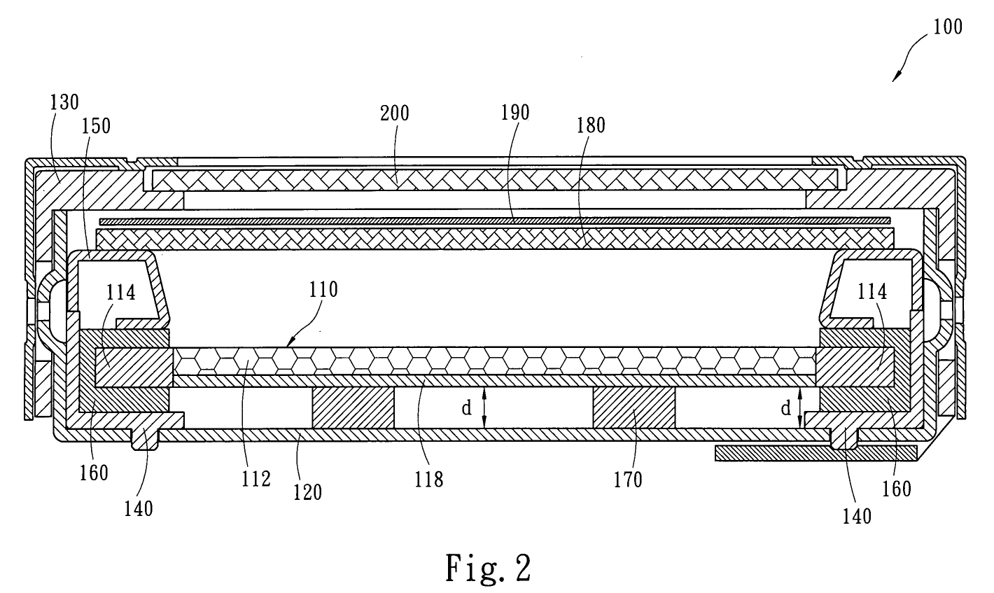

A backlight module 100 of the present invention, as shown in FIG. 2, includes a plate lamp 110, a rear frame 120, a front frame 130, a plurality of plate lamp supporting elements 140, a plurality of diffuser plate supporting elements 150, a plurality of buffer elements 160, 170, a diffuser plate 180 and an optical film layer 190.

The plate lamp supporting elements 140 are disposed on the rear frame 120, and the diffuser plate supporting elements 150 are disposed over the plate lamp supporting elements 140. The plate lamp supporting elements 140 and the diffuser plate supporting elements 150 clamp the edges of the plate lamp 110 to enable the plate lamp 110 to be accommodated inside the rear frame 120.

It is to be noted that the edges of the plate lamp 110 are firstly wrapped by the buffer elements 160 before the plate lamp 110 is clamped and fixed by the plate lamp supporting elements 140 and the diffuser plate supporting elements 150. In other words, it is through the buffer elements 160 that the plate lamp supporting elements 140 and the diffuser plate supporting elements 150 clamp and fix the edges of the plate lamp 110. The plate lamp 110 has a light-emitting region 112 and a non-light-emitting region 114, and the non-light-emitting region 114 is along the periphery of the light-emitting region 112; thus it is to be a preferred embodiment that the buffer elements are designed to wrap the non-light-emitting region 114 of the plate lamp 110, lest the light-emitting efficiency of the plate lamp 110 would be affected.

Further, the buffer elements 170 are disposed between the plate lamp 110 and the rear frame 120, and maintain a predetermined spacing d between the plate lamp 110 and the rear frame 120. In other words, after being fixed by the plate lamp supporting elements 140 and the diffuser plate supporting elements 150, the plate lamp 110 does not contact the rear frame 120 directly, but keeps a uniform spacing from the rear frame 120 via the plurality of buffer elements 170.

Furthermore, the front frame 130 is disposed over the rear frame 120 in order to fix the plate lamp 110 fixedly between the front frame 130 and the rear frame 120. The above-mentioned diffuser plate supporting elements 150 can further be utilized to support the diffuser plate 180 in order to improve the brightness uniformity. Additionally, one or a plurality of optical film layers 190, such as a light-enhancing sheet, can be disposed over the diffuser plate 180 selectively, in order to improve the total performance of the brightness. Moreover, a liquid crystal panel 200, which utilizes the light source provided by the backlight module 100, is disposed over the front frame 130; thus, the displaying function is enabled.

Referring to FIG. 2 also, by disposing a plurality of buffer elements 160, 170, when an external force impacts the backlight module 110, the buffer elements 160, 170 can absorb or disperse the impact force, so that the plate lamp 110 is protected from the damage resulting from the external force. In other words, the backlight module 100 of the present invention is resistant to vibration after installing the buffer elements 160, 170. The buffer element 160, 170 can be foam, an anti-fire CR silicone rubber, a plastic or a rubber, etc. Obviously, the spacing and tightly-clamped state between the plate lamp 110 and the diffuser plate 180 can be further assured via a preset pre-strain of the buffer elements 160, 170 in order to enable the vibration to be completely absorbed by the buffer elements 160, 170, and reduce the opportunity of the relatively movement between the plate lamp 110 and the buffer elements 160, 170 induced by impact or vibration, so that the vibration-resistance and the impact-resistance of the backlight module 110 are enhanced.

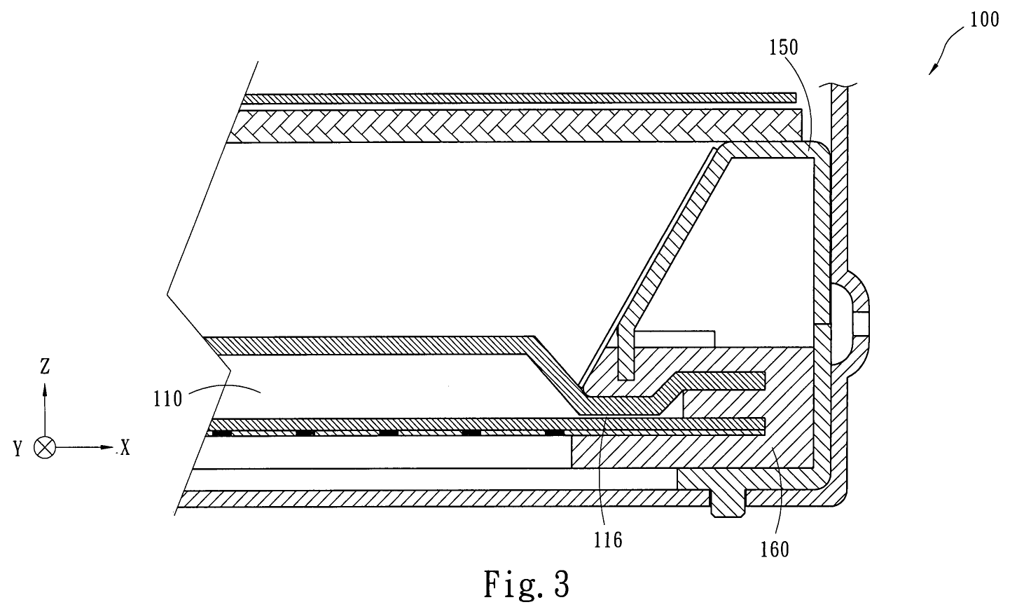

FIG. 3 illustrates one preferred embodiment of the buffer element disposed in the edge of the plate lamp. The above-mentioned buffer elements 160 wrap the edges of the plate lamp 110; however, in this embodiment, the buffer elements 160 are preferred to wrap the sealed region 116 of the plate lamp 110 rather than wrap the edges of the plate lamp 110. As the sealed region 116 is the region where two glass substrates contact each other and are glued together, the sealed region 116 is the portion of the strongest structure in the entire plate lamp 110; thus, disposing the buffer elements 160 in this portion can provide a better support and buffer function.

Further, the above-mentioned diffuser plate supporting element 150 can be designed that a portion of the diffuser plate supporting element 150 is embedded into the buffer element 160 along the Z-axis direction shown in the drawing, and the other portions constrain the buffer element 160 along the X-axis and Y-axis direction shown in the drawing; thus, the displacements of the plate lamp 110 in the X-axis, Y-axis and Z-axis direction are limited, and the fixing effect is therefore achieved.

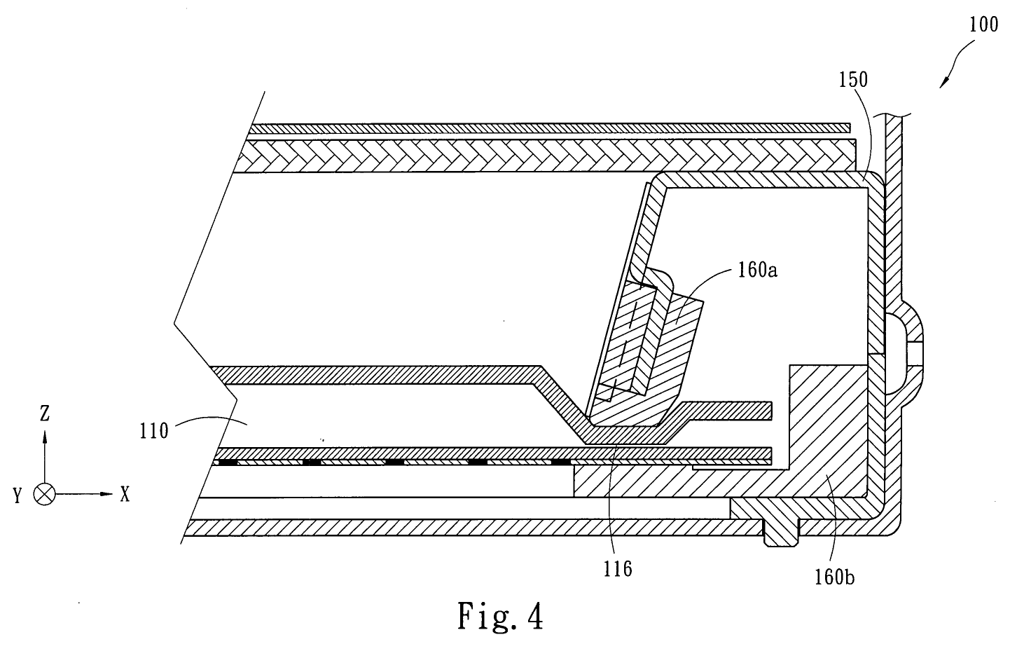

FIG. 4 illustrates another preferred embodiment of the buffer element disposed in the edge of the plate lamp. It is in an integral whole that the above-mentioned buffer element 160 wraps the plate lamp 110; however, it is to be appreciated by the persons skilled in the art that the buffer element 160 is not limited to wrapping the plate 160 in an integral whole. In this embodiment, the above-mentioned buffer element 160 is changed with two separate buffer elements 160a, 160b, wherein the buffer element 160a is disposed over the plate lamp 110, and the buffer element 160b is disposed between the plate lamp 110 and the rear frame 120 in order to clamp the edge of the plate lamp fixedly. Similar to that mentioned above, a portion of the diffuser plate supporting element 150 can be embedded into the buffer element 160a along the Z-axis direction shown in the drawing in order to constrain the buffer element 160a onto the sealed region 116 of the plate lamp 110; thus, the displacement of the plate lamp 110 in Z-axis direction is limited, and the positioning effect is therefore achieved, too.

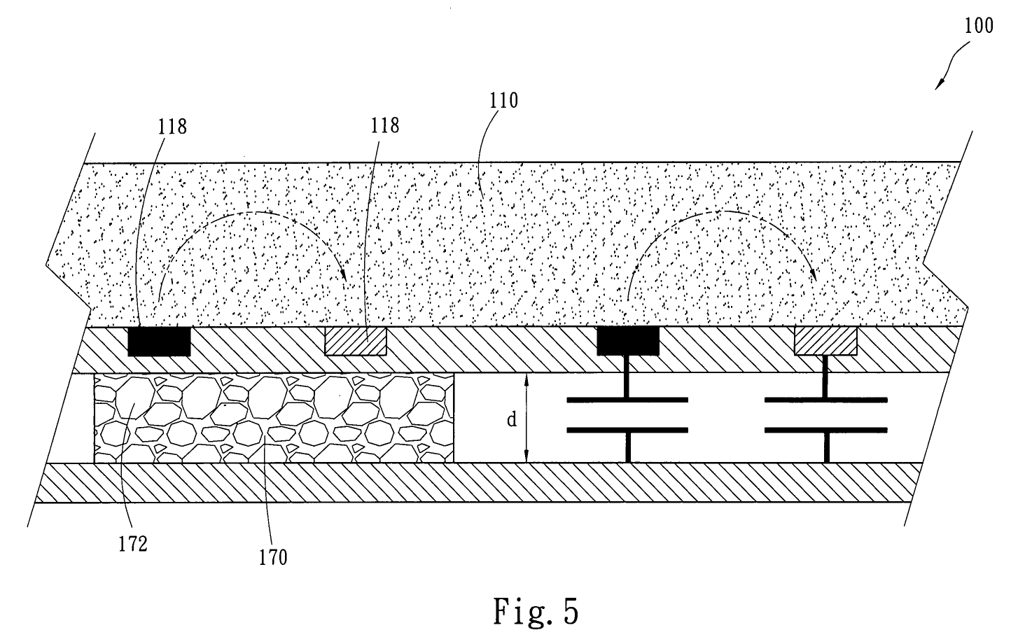

Referring to FIG. 2 and FIG. 5, the above-mentioned buffer elements 170 disposed below the bottom of the plate lamp 110 not only have the vibration-resistant effect but also can maintain a predetermined spacing d between the plate 110 and the rear frame 120 in order to maintain the flatness of the rear frame 120 while the size of the backlight module 100 trends to grow larger and larger. In the external-electrode type plate lamp 110, the electrodes 118 are disposed on the surface of the plate lamp 110. In order to avoid the current leakage resulting from that the electrode 118 of the plate lamp 110 contacts the rear frame 120 through the buffer element 170, the buffer element 170 can be made of a foamed insulating buffer material with a plurality of pores 172 in this embodiment. As the pore 172 is full of air, the dielectric constant K of the buffer element 170 is near one; thus, the current leakage can be avoided. From the above discussion, it is to be known that the current leakage, which affects the discharge phenomenon inside the light-emitting cavity of the plate lamp 110, can be avoided by selecting the material of the buffer element 170, and consequently, the light-emitting efficiency, brightness uniformity, and operation can be maintained.

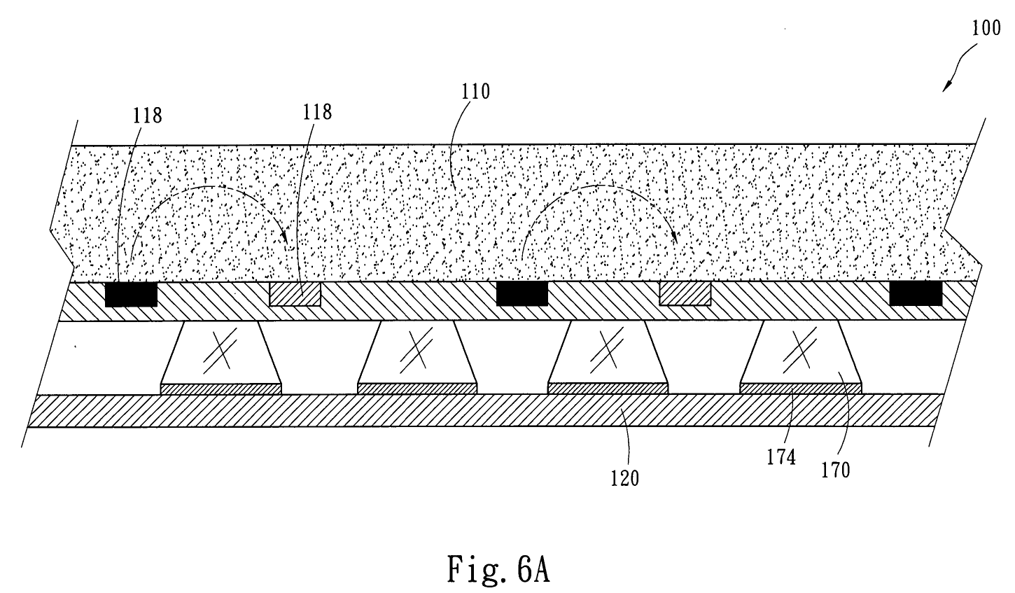

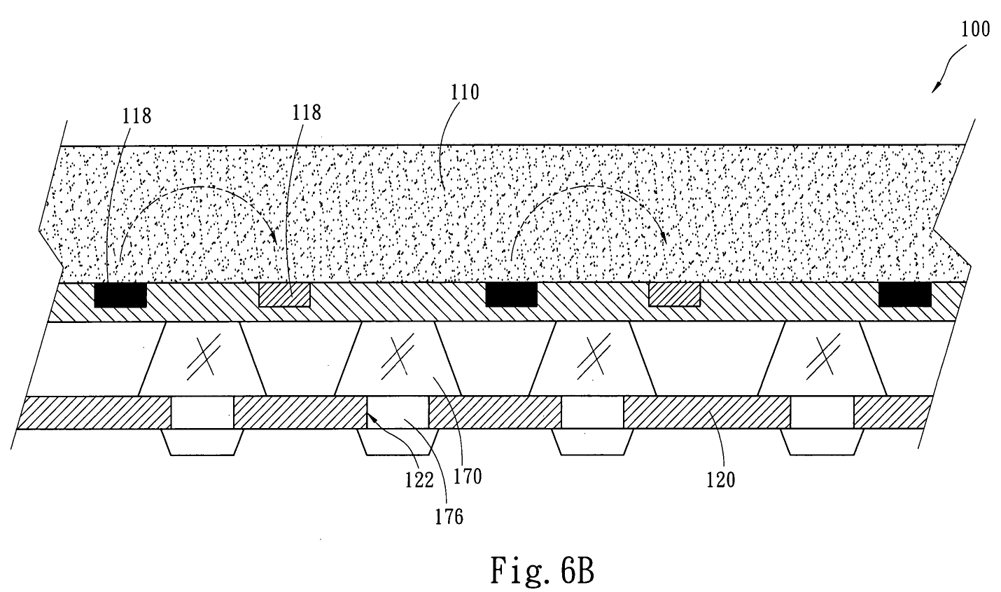

Referring to FIG. 6A and FIG. 6B, the buffer elements 170 disposed on the rear frame 120 can be fixed to the rear frame 120 by gluing or wedging. In the example shown in FIG. 6A, a glue agent 174 is coated between the buffer elements 170 and the rear frame 120, and the buffer elements 170 are then glued on the rear frame 120. In the example shown in FIG. 6B, each of the buffer element 170 is designed to have a fixing bolt 176 thereunder, and correspondingly, a plurality of positioning holes 122 are formed on the rear frame 120, wherein the outer diameter of the bottom of the fixing bolt 176 is larger than that of other portions of the fixing bolt 176, and a little larger than the diameter of the positioning hole 122. By the soft material of the buffer element 170, the bottom of the fixing bolt 176 can be deformed to pass through the positioning hole 122 to wedge therewith; thus, the buffer element 170 is fixed to the rear frame 120. In FIG. 6A and FIG. 6B, the buffer element 170 is used to exemplify that the buffer element can be fixed to the rear frame 120 by gluing or wedging; however, the person skilled in the art should easily appreciate that the buffer element 160 disclosed above can also be fixed to the rear frame 120 by gluing or wedging.

Referring to FIG. 6A and FIG. 6B also, for solving the aforementioned problem of the current leakage resulting from that the electrode 118 of the plate lamp 110 contacts the rear frame 120 via the buffer element 170, the buffer elements 170 can be further disposed between electrodes 118; thus, the buffer elements 170 is no longer the medium conducting the leaking current, and thus, the light-emitting efficiency, brightness uniformity, and electric operation of the plate lamp 110 can be maintained.

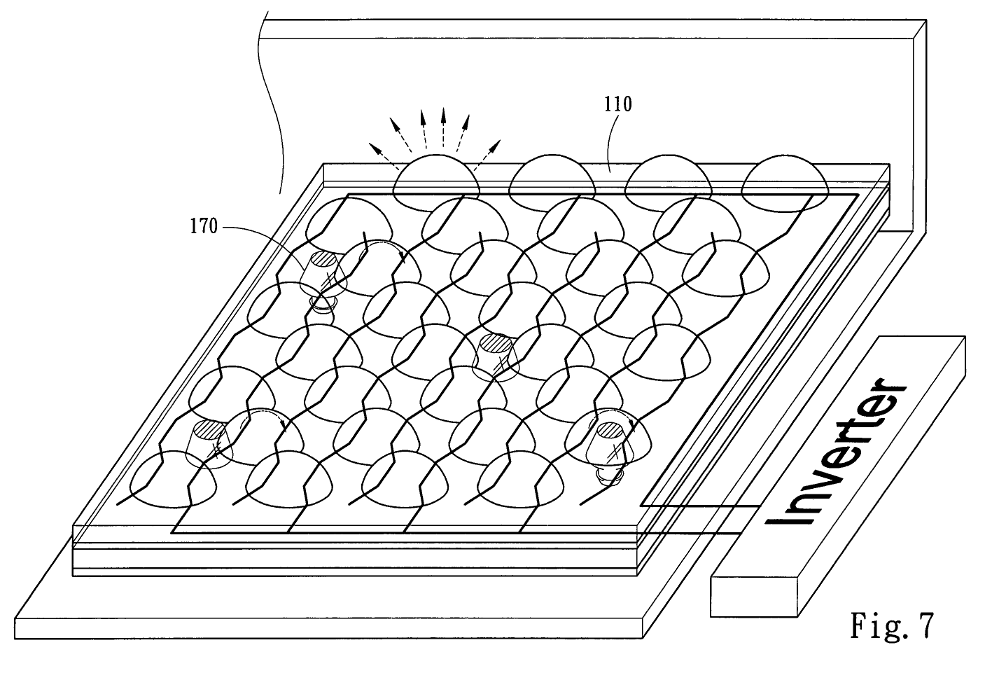

Referring to FIG. 7, a circular truncated cone exemplifies the shape of the above-mentioned buffer element 170. Obviously, it is needless to limit the shape of the buffer element 170, and the shape of the buffer element 170 can also be a grain, a block, or a square bar.

Referring to FIG. 2 again, the plate lamp 110 is clamped and fixed by both the plate lamp supporting element 140 and the diffuser plate supporting element 150 in those preferred embodiments of the present invention. It is obvious that the plate lamp supporting element 140 and the diffuser plate supporting element 150 can also be fabricated all-in-one and integrated into a single clamping component. Further, it is to be appreciated by the person skilled in the art that the buffer element 160 can also be designed to have both vibration-resistant and clamp-fixing functions in order to omit the plate lamp supporting element 140 and the diffuser plate supporting element 150. Although disposing the buffer elements in the edges and below the plate lamp has been described in those preferred embodiments, the backlight module of the present invention is not limited to that the buffer elements have to be installed both in the edges and below the bottom of the plate lamp; the positions of the buffer element can also be selected according to the need of the product.

In conclusion, the backlight module of the present invention has at least the following advantages:
1. disposing the buffer elements in the edges and/or below the plate lamp for the backlight module to have a vibration-resistance, so that the plate lamp is protected from the damage resulting from an external force;
2. disposing the buffer elements below the plate lamp not only having the vibration-resistant effect, but also maintaining a uniform spacing between the plate lamp and the rear frame, so that the light-emitting efficiency, brightness uniformity, and operation are maintained;
3. disposing the buffer elements in the edges and/or below the bottom of the plate lamp when permitted by the structural design for not only substituting the conventional plate lamp supporting element and diffuser plate supporting element, but also having the clamp-securing function also, in addition to the buffer function.

The present invention has been disclosed above by the preferred embodiments; however, it is not intended to limit the scope of the present invention. Any equivalent modification and variation can be easily performed by those skilled in the art according to the spirit of the present invention; however, it will not depart from the scope of the present invention. The scope of the present invention is to depend on the claims appended below.

What is claimed is:

1. A backlight module, comprising:
a plate lamp;
a rear frame supporting said plate lamp; and
at least a first buffer element disposed on said rear frame and wrapping the edge of said plate lamp for buffering an external force acting on said plate lamp.

2. The backlight module according to claim 1, wherein said plate lamp has a light-emitting region and a non-light-emitting region, and said first buffer element wraps said non-light-emitting region.

3. The backlight module according to claim 1, further comprising a diffuser plate and a plurality of diffuser plate supporting elements, wherein said diffuser plate is disposed between a front frame and said plate lamp and supported by said diffuser plate supporting elements, and each of said diffuser plate supporting elements is disposed over said rear frame.

4. The backlight module according to claim 1, wherein said plate lamp has a sealed region at the edges thereof, and said first buffer element wraps said sealed region.

5. The backlight module according to claim 1, wherein said first buffer element is selected from a silicone rubber, foam, a plastic and a rubber.

6. The backlight module according to claim 1, further comprising a plurality of second buffer elements disposed between said plate lamp and said rear frame for maintaining a specified spacing between said plate lamp and said rear frame.

7. The backlight module according to claim 6, wherein said second buffer elements are made of a foamed insulating buffer material with a plurality of pores.

8. The backlight module according to claim 6, wherein a surface of said plate lamp near said rear frame has a plurality of electrodes, and said second buffer elements are positioned between said electrodes.

9. The backlight module according to claim 6, wherein said first and second buffer elements are fixed to said rear frame with a gluing means.

10. The backlight module according to claim 6, wherein said first and second buffer elements are fixed to said rear frame with a wedging means.

11. The backlight module according to claim 6, wherein said first and second buffer elements are selected from a silicone rubber, foam, a plastic and a rubber.

12. The backlight module according to claim 6, wherein the shape of said second buffer elements can be selected from a circular truncated cone, a grain, a block, and a square bar.

13. A backlight module comprising:
a plate lamp;
a rear frame supporting said plate lamp; and
a plurality of buffer elements disposed between said plate lamp and said rear frame and for maintaining a specified spacing between said plate lamp and said rear frame for buffering an external force acting on said plate lamp and maintain the light-emitting efficiency, brightness uniformity and operation.

14. The backlight module according to claim 13, wherein a surface of said plate lamp near said rear frame has a plurality of electrodes, and said buffer elements are positioned between said electrodes.

15. The backlight module according to claim 13, wherein said buffer elements are fixed to said rear frame by a gluing means.

16. The backlight module according to claim 13, wherein said buffer elements are fixed to said rear frame by a wedging means.

17. The backlight module according to claim 13, wherein said buffer elements are selected from a silicone rubber, foam, a plastic, and a rubber.

18. The backlight module according to claim 13, wherein said buffer elements are made of a foamed insulating buffer material with a plurality of pores.

19. The backlight module according to claim 13, wherein the shape of said buffer elements can be selected from a circular truncated cone, a grain, a block, and a square bar.
